(19) United States
(12) Patent Application Publication
(10) Pub. No.: US 2018/0237102 A1
(43) Pub. Date: Aug. 23, 2018

(54) ADAPTER DEVICE FOR CONNECTING A VEHICLE CONTROL UNIT TO A VEHICLE COMPONENT

(71) Applicant: BLOKS. AG, Schaan (LI)

(72) Inventor: Daniel MEERMANN, Munchen (DE)

(73) Assignee: BLOKS. AG, Schaan (LI)

(21) Appl. No.: 15/754,824

(22) PCT Filed: Aug. 26, 2016
(86) PCT No.: PCT/EP2016/070259

§ 371 Date: Feb. 23, 2018

(30) Foreign Application Priority Data
Aug. 26, 2015 (DE) 10 2015 216 328.8
Aug. 26, 2015 (DE) 10 2015 216 338.5
Aug. 26, 2015 (DE) 10 2015 216 345.8
Aug. 26, 2015 (DE) 10 2015 216 346.6
Aug. 26, 2015 (DE) 10 2015 216 347.4
Aug. 26, 2015 (DE) 10 2015 216 349.0
Aug. 26, 2015 (DE) 10 2015 216 350.4
Aug. 26, 2015 (DE) 10 2015 216 351.2

(51) Int. Cl. B62K 23/02; B62J 6/16

(52) U.S. Cl. CPC B62K 23/02; B62M 6/45; B62J 6/16

(57) ABSTRACT

An adapter device (1) for establishing a connection between an electronic control unit (20) for a vehicle, in particular for a conventional bicycle or a light electric vehicle such as an electric bicycle or an electric scooter, and an electronic vehicle component (30) comprises a first cable (5A, 5B) configured to be connected to the electronic control unit (20), an adapter electronics (4A, 4B), and a second cable (6A, 6B) configured to be connected to the electronic vehicle component (30A, 30B). In this case, the adapter electronics (4A, 4B) is connected between the first cable (5A, 5B) and the second cable (6A, 6B) and is configured to receive first messages, which are sent from the electronic control unit (20) via the first cable (5A, 5B) in accordance with a first data protocol, to translate the received first messages into second messages in accordance with a second data protocol, and to send the second messages to the electronic vehicle component (30A, 30B) via the second cable (6A, 6B).

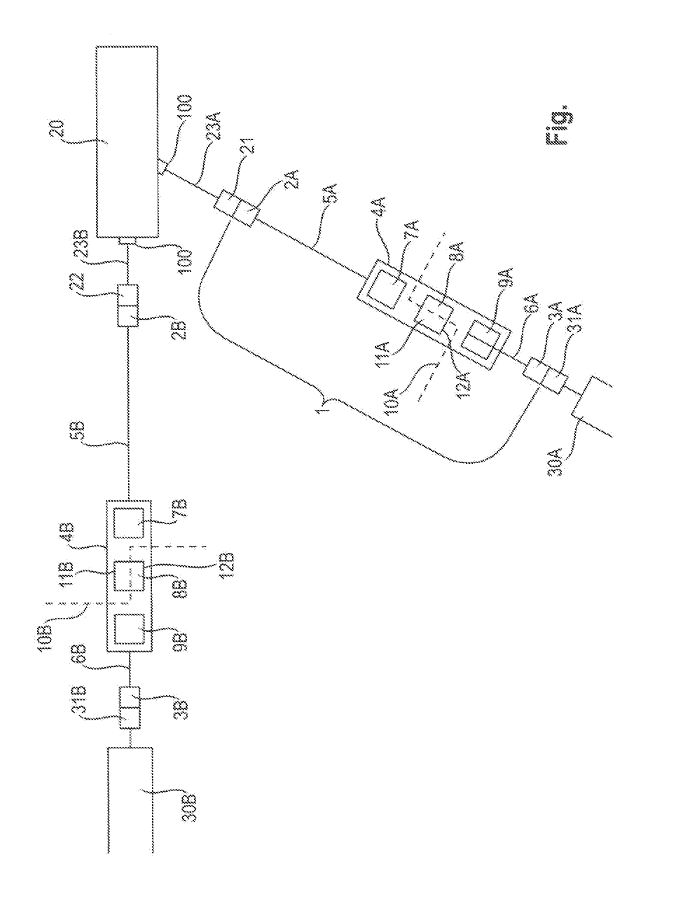

The present invention relates to an adapter device for establishing a connection, in particular a communications connection, between an electronic control unit for a vehicle, in particular for a conventional bicycle or a light electric vehicle, for example an electric bicycle or an electric scooter, and an electronic vehicle component.

Conventional bicycles and light electric vehicles, such as electric bicycles or electric scooters, are increasingly being equipped with electronic vehicle components, such as operating units, sensors or actuators, to increase the safety or comfort of a user.

In this instance, electronic vehicle or bicycle components of the same category, such as lamps, electronic gearshifts, electronic locks, etc. from different manufacturers usually have a large overlap with regard to the data sent from the electronic bicycle component to a display and operating element and the commands sent from the display and operating element to the electronic bicycle component. In electronic gearshifts, these data may include, for example, information about a currently engaged gear, and the commands may include an instruction to shift down or up a gear.

Despite this large overlap, each manufacturer implements the data and commands received or sent by their electronic vehicle components differently, also in order to differentiate themselves from competitors. The different configuration of the data protocols of different electronic vehicle components of the same category used to transmit the data and commands results in error-prone fragmentation, makes the integration of electronic vehicle components in a vehicle considerably more difficult and may result in incompatibilities between electronic vehicle components of the same category.

With the increase in electronic vehicle components to be integrated under the control of a single electronic control unit, the number of different electrical requirements, such as the supply voltage, the nominal and maximum amperage, etc., the number of data protocols to be integrated, and the number of different plug connectors to be installed increases.

Solutions on the market attempt to address this fragmentation by standardization, for example, by using electronic vehicle components having a uniform supply voltage and using uniform data protocols as well as standardized plug connectors. However, for the manufacturers of electronic vehicle components such approaches to standardization mean that, on the one hand, compatible microcontrollers having sufficient memory and compatible transceivers must be installed and, on the other hand, corresponding software for communication between the electronic control unit and the electronic vehicle component of the company defining the data protocol has to be licensed. Together with proprietary connection technology, this creates a solution in which a dependency on these upstream suppliers exists and the simple interchangeability with the electronic vehicle components of third-party manufacturers is made possible. However, even with this approach, it is necessary for manufacturers to offer at least one additional and possibly more expensive variant for conventional vehicle concepts which do not require a data bus connection.

It is an object of the present invention to provide a possibility for facilitating the integration of electronic vehicle components of different manufacturers in one vehicle.

This object is achieved by an adapter device for establishing a connection between an electronic control unit for a vehicle and an electronic vehicle component according to claim 1.

Further preferred embodiments of the invention are defined in the dependent claims.

An adapter device according to one embodiment for establishing a connection, in particular a communications connection, between an electronic control unit for a vehicle, in particular for a conventional bicycle or a light electric vehicle, for example an electric bicycle or an electric scooter, and an electronic vehicle component comprises a first cable configured to be connected to the electronic control unit, an adapter electronics, and a second cable configured to be connected to the electronic vehicle component, the adapter electronics being connected between the first and the second cable and being configured to receive first messages sent from the electronic control unit via the first cable in accordance with a first data protocol, to translate the received first messages into second messages in accordance with a second data protocol, and to send the second messages via the second cable to the electronic vehicle component.

An onboard electrical system used by the electronic control unit for communication with other devices, which system comprises a first data bus having at least one core or line of the first cable, via which the first messages are sent in accordance with the first data protocol, can use a bus system which requires few lines and correspondingly small cable cross sections, and thereby makes possible compact electronic plug connectors with the aid of small-sized plug connectors or sockets. In this case, the first data bus can be designed, for example, as a local interconnect network (LIN) bus system.

Since, for example, many boreholes in bicycle frames have a uniform diameter of 8 mm and slots correspondingly have an opening area of 8 mm×16 mm, by using the adapter device, the wiring of the electronic vehicle components can be designed in an industry-compatible manner.

In contrast, the electronic vehicle component may be configured to communicate with other devices via a second data bus according to the second data protocol, which may be different from the first data bus, the second data bus having at least one core or line of the second cable and the second messages, which are sent from the adapter electronics in accordance with the second data protocol, are received via the second data bus by the electronic vehicle component. In this case, the second data bus can be designed, for example, as a controller area network (CAN) bus system.

Preferably, the adapter electronics is furthermore configured to receive third messages sent from the electronic vehicle component via the second cable or the second data bus in accordance with the second data protocol, to translate the received third messages into fourth messages in accordance with the first data protocol, and to send the fourth messages via the first cable or the first data bus to the electronic control unit.

The translation between the first data protocol of the onboard electrical system and the second proprietary data protocol of the manufacturer of the electronic vehicle component of a specific category which includes the corresponding data and commands, carried out with the aid of the adapter electronics, can significantly facilitate the integration of the electronic vehicle component, and incompatibilities between electronic vehicle components can be avoided.

In this instance, in particular, the second proprietary data protocol of the manufacturer is translated into a first data protocol generic to the onboard electrical system for this category, so that the first data protocol internal to the onboard electrical system represents an abstraction of the actually connected electronic vehicle components, the first data protocol as part of the onboard electrical system preferably comprising the features and characteristics of all the electronic vehicle components of all categories available on the market.

Preferably, the adapter electronics has a microcontroller, which is configured to translate the first messages into the second messages and to translate the third messages into the fourth messages.

Preferably, the adapter electronics is furthermore configured to convert a first voltage supplied by the electronic control unit via the first cable into a second voltage, and to supply the second voltage to the electronic vehicle component via the second cable.

For this purpose, the microcontroller can be configured to be operated by the first voltage supplied by the electronic control unit via the first cable.

Furthermore, the second voltage may correspond to a supply voltage required for operating the electronic vehicle component. In this way, by using the adapter device, the electronic vehicle component can be supplied with the supply voltage required for the operation of the electronic vehicle component, so that no separate cables are required in addition to the adapter device for supplying the supply voltage to the electronic vehicle component.

Furthermore, the adapter device may comprise a voltage supply which is configured to convert the first voltage into the second voltage.

The adapter electronics can be configured to send a fifth message for initializing a start program or boot loader for a control unit of the electronic vehicle component, stored in the electronic vehicle component, to the electronic vehicle component via the second cable or the second data bus, or to send a sixth message for initializing a start program for a control unit of a component connected downstream, stored in one of the components connected downstream of the electronic vehicle component, to the component connected downstream via the second cable or the second data bus.

Furthermore, the adapter electronics may be configured to send a seventh message for programming the electronic vehicle component to the electronic vehicle component via the second cable or the second data bus, or to send an eighth message for programming the component connected downstream to the component connected downstream via the second cable or the second data bus.

The component connected downstream may, for example, be an integrated circuit, and a parameterization of a module of the charging circuit may take place, for example, by the initialization and the programming.

In the adapter electronics, firmware or basic firmware for detecting a plurality of electronic vehicle components of different types can be stored at the time of production, so that this basic firmware is stored in the adapter electronics upon delivery of the adapter device, the adapter electronics being configured, when connecting a particular electronic vehicle component to the second cable, to determine whether the particular electronic vehicle component is one of the plurality of electronic vehicle components, and in the event that the particular electronic vehicle component is one of the plurality of electronic vehicle components, to send a message via the first cable or the first data bus to the electronic control unit for requesting firmware required for communication with the specific electronic vehicle component.

Furthermore, the adapter electronics may comprise a transceiver configured to receive messages sent by the electronic control unit via the first cable or the first data bus, and to send messages to the electronic control unit via the first cable or the first data bus, and to receive messages sent from the electronic vehicle component via the second cable or the second data bus, and to send messages to the electronic vehicle component via the second cable or the second data bus.

In this instance, the type of transceiver module used is determined by the type of second data bus, which may be a CAN or LIN data bus, for example. In one embodiment, the transceiver may comprise a first transceiver module for communicating with the electronic control unit and a second transceiver module for communicating with the electronic vehicle component.

The adapter device may further comprise a first plug connector, which is configured to be connected to a plug connector connected to the electronic control unit, and a second plug connector, which is configured to be connected to a plug connector connected to the electronic vehicle component.

In one embodiment, the adapter device may be formed as a single component.

The adapter device according to the invention having an integrated adapter electronics thus enables the cost-effective connection of conventional electronic vehicle or bicycle components. This integration does not require any hardware adjustments and can be carried out at any time along the supply chain, which includes the component manufacturer, vehicle manufacturer, fleet operator and vehicle dealer, or may be carried out in vehicles already in the field. For this purpose, the adapter device is configured to the extent that it is component-specific with respect to the supply voltage required by the electronic vehicle component by a suitably configured power supply and is adapted to the plug connector fixedly connected to the electronic vehicle component, so that any modifications can be made exclusively by reprogramming the electronic vehicle component to be integrated.

A system according to the invention for controlling an electronic vehicle component comprises an electronic control unit and one of the adapter devices described above.

An arrangement according to the invention comprises the system for controlling an electronic vehicle component and an electronic vehicle component.

A vehicle according to the invention, in particular a conventional bicycle or a light electric vehicle, such as an electric bicycle or an electric scooter, comprises the system for controlling an electronic vehicle component. In this instance, the vehicle may further have an electronic vehicle component.

The interfaces provided by the electronic vehicle components, designed as sensors and actuators, to the onboard electrical system, which is controlled by the electronic control unit, can comprise both data and commands.

With the aid of the provided interfaces, data of a brightness sensor in an electronic vehicle component designed as a bicycle lamp, for example, can be sent as messages via the adapter device and the first data bus or the vehicle electrical system to the electronic control unit. In this case, for example, commands from the electronic control unit for instructing the bicycle lamp, based on an inclination angle of the vehicle determined by the electronic control unit, to assume a certain predefined angular position for implementing a cornering light function may be sent as messages to the electronic vehicle component.

The adapter device according to the invention is mechanically usable only with compatible plug connectors/sockets of the same type of respective electronic control units and electronic vehicle components. When starting the vehicle, the adapter electronics recognizes, on the basis of a hand-shake method (challenge-response method or PKI (public key infrastructure) method), which electronic vehicle component is connected.

The capabilities of an electronic vehicle component disclosed by the interfaces provided by the electronic vehicle component are defined by the second data protocol agreed between the electronic vehicle component and the adapter electronics. Because the adapter electronics or indirectly the electronic control unit can initialize the start program of the electronic vehicle component, the second data protocol and thus the disclosed capabilities can be changed at any time. Thus, the adapter electronics system can be programmed with basic firmware for detecting an electronic vehicle component at the time of manufacture to request, when recognizing for the first time an electronic vehicle component, the firmware required for communication with the electronic vehicle component from the electronic control unit communicating with the adapter electronics via the onboard electrical system. In this way, a generic adapter electronics can be adapted dynamically to the respective vehicle concept.

For this purpose, the manufacturer of the electronic vehicle component does not have to make any modification to the hardware or software of its existing solution for conventional vehicle concepts, which do not require a bus connection. The manufacturer thus avoids the production of different variants of their products or reduces the development and marketing risk. Instead, the vehicle manufacturer, dealer, fleet operator or end user may connect the same electronic vehicle component to the electronic control unit at the time of production, at the time of delivery, at the time of integration into the vehicle, or by retrofitting, by using the adapter device according to the invention. This means that even electronic vehicle components which were originally developed for conventional vehicle concepts can be combined, at any time and without modification, by means of the adapter device according to the invention with a corresponding electronic control unit and thus become part of a networked, intelligent vehicle concept based on a control model.

An embodiment of an adapter device for establishing a connection between an electronic control unit for a vehicle and an electronic vehicle component is described in greater detail in the following by way of the appended drawing.

The sole FIGURE schematically shows an arrangement which comprises an electronic control unit 20 for a vehicle, in particular for a conventional bicycle or a light electric vehicle, such as an electric bicycle or an electric scooter, a first electronic vehicle or bicycle component 30A, a second electronic vehicle or bicycle component 30B, a first adapter device 1 according to the invention and a second adapter device 1 according to the invention.

The two adapter devices 1 according to the invention serve to establish a respective connection, in particular a communications connection, between the electronic control unit 20 and the electronic bicycle components 30A or 30B. Furthermore, the respective adapter devices 1 serve to convert a first voltage supplied by the electronic control unit 20 into a respective second voltage or supply voltage, which is required for operating the respective electronic bicycle component 30A, 30B and which is possibly different from the first voltage, and for supplying the respective second voltage to the respective electronic bicycle component 30A, 30B. In this instance, the respective adapter devices 1 may be configured in such a manner that the second voltage supplied to bicycle component 30A is different from the second voltage supplied to electronic bicycle component 30B.

The adapter device 1 comprises an adapter electronics 4A, 4B and a first cable 5A, 5B and a second cable 6A, 6B, each of which comprises a plurality of wires or electrical lines.

A respective end of the first cable 5A, 5B and of the second cable 6A, 6B is connected to the adapter electronics 4A, 4B, the adapter electronics 4A, 4B preferably being fixedly connected to the first cable 5A, 5B and to the second cable 6A, 6B, and the adapter electronics 4A, 4B and the respective ends of the first cable 5A, 5B and of the second cable 6A, 6B together are sheathed, for example, with plastics material so that the adapter device 1 is formed by a single component.

At the other end of the first cable 5A, 5B, a plug connector 2A, 2B is provided, which is configured to be connected to a plug connector 21, 22 connected to the electronic control unit 20 via a cable 23A, 23B. At the other end of the second cable, a plug connector 3A is provided, which is configured to be connected to a plug connector 31A, which is connected to the first electronic bicycle component 30A via a cable. At the other end of the second cable 6B, a plug connector 3B is provided, which is configured to be connected to a plug connector 31B connected via a cable to the second electronic bicycle component 30B.

The electronic bicycle components 30A, 30B may, for example, be configured as sensors, such as brightness sensors or speed sensors and the like, as an operating unit for receiving a command for controlling another of the electronic bicycle components 30A, 30B or as actuators, such as a lamp, a battery, a motor, in particular as an electric motor, for actuating a light electric vehicle, such as an electric bicycle or an electric scooter, or as a battery for supplying power to the electric motor, and the like.

An onboard electrical system controlled by the electronic control unit 20 is operated with the first voltage, for example 12 V, and a current of at most 3A, and a first data protocol. A bus used in the onboard electrical system for data and command transmission or the transmission of messages between individual devices connected to the bus may be a LIN bus, for example.

In contrast, the electronic bicycle components 30A, 30B are configured to be operated with a supply voltage, for example 48V, 36V, 24V, or 6V, which corresponds to a second voltage, and to send to and receive messages from the electronic control unit 20 using a second data protocol different from the first data protocol on a bus system different from the bus system of the onboard electrical system, for example a CAN, LIN, UART, etc. bus system.

In order to establish the communications connection between the electronic control unit 20 and the two electronic bicycle components 30A, 30B and to convert the first voltage into the second voltage, the adapter electronics 4A, 4B comprises a microcontroller 12A, 12B, a transceiver 9A, 9B, and a voltage supply 7A, 7B. In this case, the microcontroller 12A, 12B and transceiver 9A, 9B are operated by the first voltage supplied from the electronic control unit 20 via the first cable 5A, 5B.

The adapter electronics 4A, 4B is configured to receive messages, which have been sent from the electronic control unit 20 via the onboard electrical system or the first data bus, which includes at least one individual line or at least one wire of the cable 23A, 23B and of the first cable 5A, 5B of the adapter device 1, in accordance with the first data protocol, to translate the received messages into messages in accordance with a second data protocol of a second data bus, which comprises at least one single line or at least one wire of the second cable 6A, 6B and the cable connecting the plug connector 31A, 31B with the electronic bicycle component 30A, 30B, and to transmit the translated messages via the second data bus to the electronic bicycle component 30A, 30B. In this instance, software executed on the microcontroller 12A, 12B can be programmed by the electronic control unit 20 by sending a corresponding message to the adapter electronics system 4A, 4B.

Furthermore, the adapter electronics 4A, 4B is configured to receive messages which are sent from the electronic bicycle component 30A, 30B via the second data bus in accordance with the second data protocol, to translate the received messages into messages in accordance with the first data protocol, and to send the translated messages via the first data bus to the electronic control unit 20.

In the following, the functionality of the adapter device 1 according to the invention will be described in greater detail using the example of message transmission between the electronic control unit 20 and the electronic bicycle component 30A.

The first plug connector 2A or the first socket 2A is configured to be connected to the plug connector 21 or the socket 21 of the cable 23A of the electronic control unit 20 in such a way that a data communication between the adapter electronics 4A and the electronic control unit 20 is enabled and that the first voltage may be supplied from the electronic control unit 20 to the adapter electronics 4A.

The second plug connector 3A or second socket 3A is configured to be connected to the plug connector 31A or socket 31A of the cable of the electronic bicycle component 30A in such a way that a data communication between the adapter electronics 4A and the electronic bicycle component 30A is enabled and that a second voltage may be supplied from the adapter electronics 4A to the electronic bicycle component 30A.

The first voltage supplied to the adapter electronics 4A is, on the one hand, used to supply the adapter electronics 4A with power or electricity and, on the other hand, the supplied first voltage is converted by the power supply 7A into the second voltage, the second voltage being supplied via the second cable 6A to the electronic bicycle component 30A to supply the electronic bicycle component 30A with power or electricity. A first data bus extends from the electronic control unit 20 into the interior of the adapter electronics 4A, for example, up to a border shown by a dashed line. A second data bus extends from the border shown as a dashed line to the electronic bicycle component 30A.

When sending a first message from the electronic control unit 20 via the first data bus in accordance with the first data protocol to the electronic bicycle component 30A, the first message is received by the transceiver 9A. The received first message is translated by the microcontroller 12A, in particular a processor 11A of the microcontroller 12A, into a second message in accordance with the second data protocol of the second data bus, and the transceiver 9A transmits the second message to the electronic bicycle component 30A via the second data bus.

When sending a third message from the electronic bicycle component 30A via the second data bus to the electronic control unit 20, the third message is received by the transceiver 9A. The received third message is translated by the microcontroller 12A, in particular the processor 11A of the microcontroller 12A, into a fourth message in accordance with the first data protocol of the first data bus, and the transceiver 9A transmits the fourth message to the electronic control unit 20 via the first data bus.

In the adapter electronics 4A, basic firmware for detecting a plurality of electronic vehicle components 30A, 30B of different types and from different manufacturers is, at the time of delivery, already stored in a memory area 8A of the microcontroller 12A. Upon start-up of the vehicle or connection of a specific electronic bicycle component 30A, 30B to the second cable 6A of the adapter device 4A by connecting the plug connector 3A to the plug connector 31A, the adapter electronics 4A recognizes with the aid of a hand-shake method, such as a challenge-response method or a public key infrastructure (PKI) method, whether the particular connected electronic bicycle component 30A is one of the plurality of electronic vehicle components 30A, 30B.

If the particular electronic vehicle component 30A is one of the plurality of electronic vehicle components 30A, 30B, the adapter device 1 sends via the first cable 5A a message to the electronic control unit 20 for requesting a firmware required for specific communication regarding data and commands with the particular electronic vehicle component 30A. Upon receipt of the request, the electronic control unit 20 sends the firmware required for the transmission of messages in the form of data and commands between the adapter electronics 4A and the electronic bicycle component 30A to the adapter electronics 4A, which stores the obtained firmware in memory area 8A.

The adapter device 1 is further configured to program software of the electronic bicycle component 30A. To this end, the adapter electronics 4A first sends a message via the second data bus for initializing a start program for a control unit of the electronic bicycle component 30A, which start program is stored in the electronic bicycle component 30A, to the electronic bicycle component 30A. After initialization or receipt of a message from the electronic bicycle component that the initialization has been completed, the adapter electronics 4A sends another message via the second data bus to the electronic bicycle component 30A which contains corresponding information for programming the electronic bicycle component 30A.

Furthermore, the adapter device 1 is configured to program software of a component (not shown) which is connected downstream of the electronic bicycle component 30A. To this end, the adapter electronics 4A first sends a message via the second data bus for initializing a start program for a control unit of the component connected downstream, which start program is stored in the component connected downstream, to the component connected downstream. After initialization, the adapter electronics 4A sends another message via the second data bus to the component connected downstream to program the component connected downstream.

1. An adapter device (1) for establishing a connection between an electronic control unit (20) for a vehicle, in particular for a conventional bicycle or a light electric vehicle, for example an electric bicycle or an electric scooter, and an electronic bicycle component (30A, 30B), comprising
a first cable (5A, 5B), which is configured to be connected to the electronic control unit (20),
an adapter electronics (4A, 4B), and
a second cable (6A, 6B), which is configured to be connected to the electronic bicycle component (30A, 30B), wherein
the adapter electronics (4A, 4B) is connected between the first cable (5A, 5B) and the second cable (6A, 6B), and is configured
to receive first messages sent from the electronic control unit (20) via the first cable (5A, 5B) in accordance with a first data protocol, to translate the received first messages into second messages in accordance with a second data protocol of the electronic bicycle component (30A, 30B), and to send the second messages via the second cable (6A, 6B) to the electronic bicycle component (30A, 30B).

2. The adapter device (1) as recited in claim 1, in which the adapter electronics (4A, 4B) is configured to receive third messages sent from the electronic bicycle component (30A, 30B) via the second cable (6A, 6B) in accordance with the second data protocol, to translate the received third messages into fourth messages in accordance with the first data protocol, and to send the fourth messages via the first cable (5A, 5B) to the electronic control unit (20).

3. The adapter device (1) as recited in claim 2, in which the adapter electronics (4A, 4B) comprises a microcontroller (12A, 12B), which is configured to translate the first messages into the second messages and to translate the third messages into the fourth messages.

4. The adapter device (1) as recited in claim 3, in which the adapter electronics (4A, 4B) is configured to convert a first voltage supplied by the electronic control unit (20) via the first cable (5A, 5B) into a second voltage, and to supply the second voltage to the electronic bicycle component (30A, 30B) via the second cable (6A, 6B).

5. The adapter device (1) as recited in claim 4, in which the microcontroller (11A, 11B) is configured to be operated by the first voltage supplied from the electronic control unit (20) via the first cable (5A, 5B).

6. The adapter device (1) as recited in either claim 4, in which the adapter electronics (4A, 4B) comprises a voltage supply (7A, 7B), which is configured to convert the first voltage into the second voltage.

7. The adapter device (1) as recited in claim 1, in which the adapter electronics (4A, 4B) is configured to send a fifth message for initializing a start program for a control unit of the electronic bicycle component (30A, 30B), which is stored in the electronic bicycle component (30A, 30B), to the electronic bicycle component (30A, 30B) via the second cable (6A, 6B), or to send a sixth message for initializing a start program for a control unit of a component connected downstream, which is stored in one of the components connected downstream of the electronic bicycle component (30A, 30B), to the component connected downstream via the second cable (6A, 6B).

8. The adapter device (1) as recited in claim 7, in which the adapter electronics (4A, 4B) is configured to send a seventh message for programming the electronic bicycle component (30A, 30B) to the electronic bicycle component (30A, 30B) via the second cable (6A, 6B), or to send an eighth message for programming the component connected downstream to the component connected downstream via the second cable (6A, 6B).

9. The adapter device (1) as recited in claim 1, in which firmware for recognizing a plurality of electronic bicycle components (30A, 30B) of different types is stored in the adapter electronics (4A, 4B), and the adapter electronics (4A, 4B) is, when connecting a particular electronic bicycle component (30A, 30B) to the second cable (6A, 6B), configured to determine whether the particular electronic bicycle component (30A, 30B) is one of the plurality of electronic bicycle components (30A, 30B), and in the event that the particular electronic bicycle component (30A, 30B) is one of the plurality of electronic bicycle components (30A, 30B), to send a message via the first cable (5A, 5B) to the electronic control unit (20) for requesting firmware required for communication with the specific electronic bicycle component (30A, 30B).

10. The adapter device (1) as recited in claim 1, in which the adapter electronics (4A, 4B) comprises a transceiver (9A, 9B), which is configured
to receive messages sent from the electronic control unit (20) via the first cable (5A, 5B), and to send messages to the electronic control unit (20) via the first cable (5A, 5B), and
to receive messages sent from the electronic bicycle component (30A, 30B) via the second cable (6A, 6B), and to send messages to the electronic bicycle component (30A, 30B) via the second cable (6A, 6B).

11. The adapter device (1) as recited in claim 1, further comprising
a first plug connector (2A, 2B), which is configured to be connected to a plug connector (21, 22) connected to the electronic control unit (20), and
a second plug connector (3A, 3B), which is configured to be connected to a plug connector (31A, 31B) connected to the electronic bicycle component (30A, 30B).

12. The adapter device (1) as recited in claim 1, in which the adapter device (1) is configured as a single component.

13. A device for controlling an electronic bicycle component (30A, 30B), comprising
an electronic control unit (20) and
an adapter device (1) as recited in claim 1.

14. An arrangement, comprising
a system for controlling an electronic bicycle component (30A, 30B) as recited in claim 13, and
an electronic bicycle component (30A, 30B).

15. A vehicle, in particular a conventional bicycle or a light electric vehicle, such as an electric bicycle or an electric scooter, comprising a system for controlling an electronic bicycle component (30A, 30B) as recited in claim 13.

16. The vehicle as recited in claim 15, further comprising an electronic bicycle component (30A, 30B).
